(19) United States
(12) Patent Application Publication
(10) Pub. No.: US 2005/0100837 A1
(43) Pub. Date: May 12, 2005

(54) Ultrahigh speed imaging assembly for orthopedic radiography

(75) Inventors: Robert E. Dickerson, Hamlin, NY (US); Phillip C. Bunch, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/706,574

(22) Filed: Nov. 12, 2003

(51) Int. Cl. G03C 5/16

(52) U.S. Cl. 430/496

(57) ABSTRACT

A radiographic imaging assembly comprises a symmetric radiographic silver halide film has an overall system speed of at least 400 and includes a phosphor intensifying screen that has a screen sharpness measurement (SSM) greater than reference Curve A of FIG. 4. Because of the specific combination of film and screen, the imaging assembly can provide a black-and-white image that can be used for orthopedic radiography without increased X-radiation exposure to the patient. The radiographic silver halide film comprises two different tabular grain silver halide emulsions on each side of the film support and the emulsions closer to the support comprise a suitable crossover control agent.

### FIELD OF THE INVENTION

This invention is directed to radiography. In particular, it is directed to a high speed radiographic imaging assembly containing a radiographic silver halide film and fluorescent intensifying screens that provides improved medical diagnostic images for orthopedic radiography at reduced imaging dosage.

### BACKGROUND OF THE INVENTION

In conventional medical diagnostic imaging the object is to obtain an image of a patient's internal anatomy with as little X-radiation exposure as possible. The fastest imaging speeds are realized by mounting a dual-coated radiographic element between a pair of fluorescent intensifying screens for imagewise exposure. About 5% or less of the exposing X-radiation passing through the patient is adsorbed directly by the latent image forming silver halide emulsion layers within the dual-coated radiographic element. Most of the X-radiation that participates in image formation is absorbed by phosphor particles within the fluorescent screens. This stimulates light emission that is more readily absorbed by the silver halide emulsion layers of the radiographic element.

Examples of radiographic element constructions for medical diagnostic purposes are provided by U.S. Pat. No. 4,425,425 (Abbott et al.) and U.S. Pat. No. 4,425,426 (Abbott et al.), U.S. Pat. No. 4,414,310 (Dickerson), U.S. Pat. No. 4,803,150 (Dickerson et al.), U.S. Pat. No. 4,900,652 (Dickerson et al.), U.S. Pat. No. 5,252,442 (Tsaur et al.), U.S. Pat. No. 5,576,156 (Dickerson), and Research Disclosure, Vol. 184, August 1979, Item 18431.

Problem to be Solved

Image quality and radiation dosage are two important features of film-screen radiographic combinations (or imaging assemblies). High image quality (that is high resolution or sharpness) is of course desired, but there is also the desire to minimize exposure of patients to radiation. Thus, “high speed” imaging assemblies are needed. However, in known imaging assemblies, the two features generally go in opposite directions. Thus, the imaging assemblies that can be used with low radiation dosages (that is, “high speed” assemblies) generally provide images with poorer quality (poorer resolution). Lower speed imaging assemblies generally require higher radiation dosages to provide sharper images.

There is a need for imaging assemblies that are useful for orthopedic radiography that require minimum radiation dosages with minimal sacrifice in image quality (for example, resolution or sharpness).

### SUMMARY OF THE INVENTION

This invention provides a solution to the noted problems with a radiographic imaging assembly that has a system speed of at least 400 and comprises:

A) a symmetric radiographic silver halide film having a film speed of at least 700 and comprising a support that has first and second major surfaces and that is capable of transmitting X-radiation,

the radiographic silver halide film having disposed on the first major support surface, two or more hydrophilic colloid layers including first and second silver halide emulsion layers, and having on the second major support surface, two or more hydrophilic colloid layers including third and fourth silver halide emulsion layers, the first and third silver halide emulsion layers being the outermost emulsion layers on their respective sides of the support,

each of the first, second, third, and fourth silver halide emulsion layers comprising tabular silver halide grains that have the same or different composition and independently an aspect ratio of at least 35 and an average grain diameter of at least 3.0 μm, and comprise at least 90 mol % bromide and up to 3 mol % iodide, both based on total silver in the grains,

the second and fourth silver halide emulsion layers comprising a crossover control agent sufficient to reduce crossover to less than 10%, and

B) a fluorescent intensifying screen arranged on each side of the radiographic silver halide film, the screen having a screen speed of at least 150 and a screen sharpness measurement (SSM) value greater than reference Curve A of FIG. 4, and comprising an inorganic phosphor capable of absorbing X-rays and emitting electromagnetic radiation having a wavelength greater than 300 nm, the inorganic phosphor being coated in admixture with a polymeric binder in a phosphor layer onto a flexible support and having a protective overcoat disposed over the phosphor layer.

In preferred embodiments of this invention, a radiographic imaging assembly has a system speed of at least 400 and comprises:

A) a symmetric radiographic silver halide film having a film speed of at least 800 and comprising a support that has first and second major surfaces and that is capable of transmitting X-radiation,

the radiographic silver halide film having disposed on the first major support surface, two or more hydrophilic colloid layers including first and second silver halide emulsion layers, and having on the second major support surface, two or more hydrophilic colloid layers including third and fourth silver halide emulsion layers, the first and third silver halide emulsion layers being the outermost emulsion layers on their respective sides of the support,

each of the first, second, third, and fourth silver halide emulsion layers comprising tabular silver halide grains that have the same composition, and independently an aspect ratio of from about 40 to about 50, an average grain diameter of at least 4.0 μm, and an average thickness of from about 0.09 to about 0.11 μm, and comprise at least 98 mol % bromide and up to 0.5 mol % iodide, both based on total silver in the grains,

each of the second and fourth silver halide emulsion layers comprising a particulate oxonol dye as a crossover control agent present in an amount of from about 1 to about 1.3 mg/m² that is sufficient to reduce crossover to less than 8% and that is decolorized during development within 45 seconds,

the film further comprising a protective overcoat on both sides of the support disposed over all of the silver halide emulsion layers,

wherein the tabular silver halide grains in the first, second, third, and fourth silver halide emulsion layers are dispersed in a hydrophilic polymeric vehicle mixture comprising from about 0.25 to about 1.5% of deionized oxidized gelatin, based on the total dry weight of the polymeric vehicle mixture,

wherein the dry, unprocessed thickness ratio of the first silver halide emulsion layer to that of the second silver halide emulsion layer is from about 3:1 to about 1:1, and the dry, unprocessed thickness ratio of the third silver halide emulsion layer to that of the fourth silver halide emulsion layer is independently from about 3:1 to about 1:1, and

wherein the molar ratio of silver in the first silver halide emulsion layer to that of the second silver halide emulsion layer is from about 1.5:1 to about 3:1, and the molar ratio of silver in the third silver halide emulsion layer to that of the fourth silver halide emulsion layer is independently from about 1.5:1 to about 3:1, and

B) a fluorescent intensifying screen having a screen speed of at least 150 and a screen sharpness measurement (SSM) value of at least 1.1 times that of reference Curve A of FIG. 4 at a given spatial frequency, and that comprises a terbium activated gadolinium oxysulfide phosphor capable of absorbing X-rays and emitting electromagnetic radiation having a wavelength greater than 300 nm, the phosphor being coated in admixture with a polymeric binder in a phosphor layer onto a flexible polymeric support and having a protective overcoat disposed over the phosphor layer.

This invention also provides a method of providing a black-and-white image comprising exposing the radiographic silver halide film in the radiographic imaging assembly of the present invention and processing the film, sequentially, with a black-and-white developing composition and a fixing composition, the processing being carried out within 90 seconds, dry-to-dry. The resulting black-and-white images can be used for a medical diagnosis.

The present invention provides a means for providing very sharp radiographic images having high detail that can be used in orthopedic examinations. This improved image quality is obtained without increasing imaging X-radiation dosage because of the high photographic speed (at least 400) provided by the unique combination of film and screen.

In addition, all other desirable sensitometric properties are maintained and the radiographic film of the imaging assembly can be rapidly processed in conventional processing equipment and compositions.

These advantages are achieved by using a novel combination of a symmetric radiographic silver halide film and fluorescent intensifying screen. The symmetric radiographic silver halide film has a film speed of at least 400 and a unique set of two silver halide emulsion layers on both sides of the film support comprising tabular silver halide grains having specific halide compositions, grain sizes and aspect ratios. In addition, the silver halide emulsion layers closest to the support on both sides comprise crossover control agents. In preferred embodiments, the tabular grains in all four silver halide emulsion layers are dispersed in a polymeric binder mixture that includes at least 0.25 weight % of oxidized gelatin (based on total dry weight of the polymeric binder mixture). With the unique choice of fluorescent intensifying screen and radiographic film of this invention, images with increased sharpness can be obtained. Such image quality improvements can be characterized by SSM values being greater than the values represented by reference Curve A of FIG. 4 over the range of spatial frequencies.

### BRIEF DESCRIPTION OF THE DRAWINGS

FIG. 1 is a simplified schematic representation of a test system used to determine SSM values.

FIG. 2 is a graphical representation of the X-radiation waveform obtained from a typical test system used to determine SSM values.

FIG. 3 is a graphical representation of a Fourier transform of data obtained from repetitions of X-radiation waveforms.

FIG. 4 is a graphical representation of SSM vs. spatial frequencies for the imaging assembly of the present invention described in the Example using Film B and Screen W.

### DETAILED DESCRIPTION OF THE INVENTION

Definition of Terms:

The term “contrast” as herein employed indicates the average contrast derived from a characteristic curve of a radiographic film using as a first reference point (1) a density (D₁) of 0.25 above minimum density and as a second reference point (2) a density (D₂) of 2.0 above minimum density, where contrast is ΔD (i.e. 1.75)÷Δlog₁₀E (log₁₀E₂−log₁₀E₁), E₁ and E₂ being the exposure levels at the reference points (1) and (2).

“Gamma” is described as the instantaneous rate of change of a D logE sensitometric curve or the instantaneous contrast at any logE value.

“System speed” is a measurement given to combinations (“systems” or imaging assemblies) of radiographic silver halide films and fluorescent intensifying screens that is calculated using the conventional ISO 9236-1 standard wherein the radiographic film is exposed and processed under the conditions specified in Eastman Kodak Company's Service Bulletin 30. In general, system speed is thus defined as 1 milliGray/Kₛ wherein Kₛ is Air Kerma (in Grays) required to achieve a density=1.0+Dₘᵢₙ+fog. In addition, 1 milliRoentgen (mR) is equal to 0.008732 milliGray (mGray). For example, by definition, if 0.1 milliGray (equal to 11.4 mR) incident on a film-screen system creates a density of 1.0 above Dₘᵢₙ+fog, that film-screen system is considered to have a speed of “10”.

However, it is common in the trade to use a “scaled” version of system speed, wherein commercially available KODAK Min-R 2000 radiographic film used in combination with a commercially available KODAK Min-R 2000 intensifying screen is assigned or designated a speed value of “150”. Bunch et al. SPIE Medical Imaging, Vol. 3659 (1999), pp. 120-130 shows that it requires 6.3 mR for such a KODAK Min-R 2000 film/screen system to reach a density of 1.0 above Dₘᵢₙ+fog. This gives an ISO speed value of 18.1 for this particular system. Thus, the relationship between the ISO speed value and the common definition of system speed is the ratio 150/18.1=8.25. That is, the numerical values of the common system speed values are 8.25 times those directly obtained using equation 7.1 of the noted ISO 9236-1 standard.

The “scaled” system speed values common in the trade are used in this application. However, they can be converted to ISO speed values by dividing them by 8.25.

In this application, “film speed” has been given a standard of “150” for a commercially available KODAK Min-R 2000 radiographic film that has been exposed for 1 second and processed according to the Service Bulletin 30 using a fluorescent intensifying screen containing a terbium activated gadolinium oxysulfide phosphor (such as Screen X noted below in the Example). Thus, if the Kₛ value for a given system using a given radiographic film is 50% of that for a second film with the same screen and exposure and processing conditions, the first film is considered to have a speed 200% greater than that of the second film. This commercially available film has also been described as Film A in U.S. Pat. No. 6,037,112 (Dickerson).

Also in this application, “screen speed” has been given a standard of “150” for a conventional KODAK Min-R 2000 screen containing a terbium activated gadolinium oxysulfide phosphor. Thus, if the Kₛ value for a given system using a given screen with a given radiographic film is 50% of that for a second screen with the same film and exposure and processing conditions, the first screen is considered to have a speed 200% greater than that of the second screen. The KODAK Min-R 2000 fluorescent intensifying screen identified above contains a terbium activated gadolinium oxysulfide phosphor (median particle size of about 3.8 to 4.0 μm) and 10 ppm (based on total phosphor weight) of finely divided carbon (0.1 to 0.5 μm) dispersed in a Permuthane U6366™ polyurethane binder on a blue-tinted poly(ethylene terephthalate) film support having a thickness of about 180 μm. The total phosphor coverage is 3.3 g/dm² and the phosphor to binder weight ratio is 21:1. The dried thickness of the phosphor layer is about 84 μm phosphor to binder weight ratio is 21:1. The dried thickness of the phosphor layer is about 84 μm. Over the phosphor layer is disposed a protective overcoat layer comprising cellulose acetate and crosslinked polystyrene matte particles present at 3% of the weight of the total overcoat. The overcoat has been coated to a dry thickness of about 6 μm.

The “screen sharpness measurement” (SSM) described herein is a parameter that has been found to correlate well with visual appearance of image sharpness if other conditions are held constant.

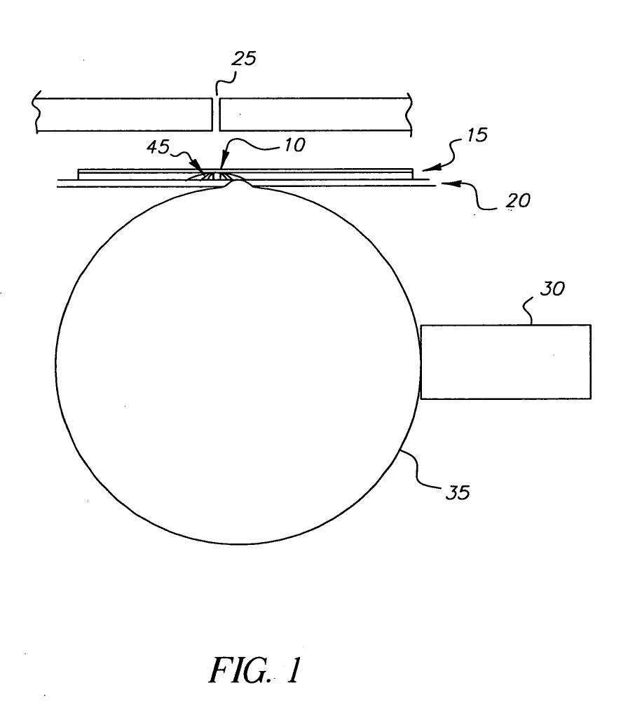

Each screen sharpness measurement described in this application was made using a test system that is described as follows as illustrated in FIG. 1. A slit-shaped X-ray exposure 10 was made onto phosphor screen sample 15 (in a front-screen configuration) that was in contact with optical slit 20. The profile or spread 45 of the emitted light from the screen was determined by scanning optical slit 20 relative to X-ray slit (or mask) 25 and digitizing the resulting signal. Photomultiplier tube 30 (PMT) was used to detect the light that passed through optical slit 20. Data processing was done during acquisition and analysis to minimize noise in the resulting light spread profile (LSP). A Fourier transform of the LSP was calculated to give the SSM as a function of spatial frequency.

In FIG. 1, a very narrow tungsten carbide mask (10-15 μm wide, about 0.64 cm thick, and about 0.64 cm long) was used as X-ray slit 25 to provide slit-shaped X-ray exposure 10. X-ray slit 25 was held fixed with respect to the source of X-radiation. Phosphor screen sample 15 was placed face down (exit surface) on top of optical slit 20 made of two pieces of sharpened tool steel. The steel had been darkened by a chemical treatment and further blackened by a black felt-tipped pen. Phosphor screen sample 15 was held in place by a piece of a carbon fiber cassette panel (not shown) that was held down by pressure from spring-loaded plungers (not shown). The light passed through optical slit 20 was collected by integrating sphere 35 and a fraction of it was then detected by PMT 30. The whole assembly of phosphor screen sample 15, optical slit 20, integrating sphere 35, and PMT 30 was translated relative to X-ray slit 25. Optical slit 20 was aligned with X-ray slit 25. As phosphor screen sample 15 was passed under X-ray slit 25, the light that passed through optical slit 20 varied according to the profile of lateral light spread within phosphor screen sample 15.

Any suitable source of X-radiation can be used for this test. To obtain the data described in this application, the X-radiation source was a commercially available Torrex 120D X-Ray Inspection System. Inside this system, the linear translation table that holds the entire assembly was under computer control (any suitable computer can be used). Integrating sphere 35 had a 4-inch (10.2 cm) diameter and was appropriately reflective. One such integrating sphere can be obtained from Labsphere. The top port of integrating sphere 35 that accepted the light from optical slit 20 was 1 inch (2.54 cm) in diameter. The side port that was used for PMT 30 was also 1 inch (2.54 cm) in diameter. While any suitable PMT can be used, we used a Hamamatsu 81925 with a quartz window for extended UV response. It was about 1 inch (2.54 cm) in diameter, and had a very compact dynode chain so the length of the PMT was minimized. High voltage was supplied to PMT 30 by a 0-1 kV power supply (not shown). A transimpedence amplifier (not shown) having a simple single RC bandwidth limitation of around 1 kHz was constructed. The signal from PMT 30 was low-pass filtered using a 24 dB/octave active filter set at a bandwidth of about 300 Hertz. A suitable computer system (for example, an Intel 486DX-33 MHz DOS computer system) was used for data acquisition and analysis. The X-radiation source was slightly modified to allow for computer control and monitoring of the unit by the computer. Two digital output lines were used for START and STOP of the X-ray tube current, and one digital input line was used to monitor the XRAY ON signal to assure that the unit was indeed on.

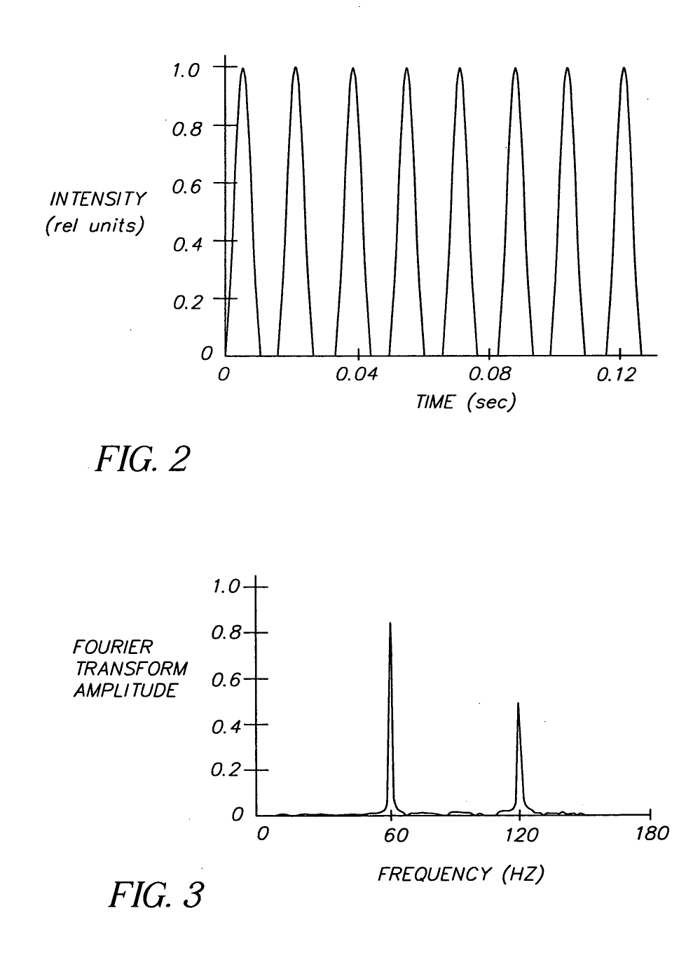

LSP was measured in the following manner. The optical slit/integrating sphere/PMT assembly was moved relative to X-ray slit 25. The X-radiation generation unit generated X-rays such that the intensity followed a 60 Hz single-wave rectified waveform in time as shown in FIG. 2. To take advantage of this, a single data point that represents the value of the LSP at a given spatial position was generated by acquiring an array of data at each spatial position using time intervals between points in this temporal array small enough such that the X-ray intensity waveform can be adequately represented by this array of data. Several repetitions of the waveform were captured in one array of data. A Fourier transform of this array of data yielded an array of data giving the amplitude of signal at various temporal frequencies that looked like that shown in FIG. 3. After the transform was done, the integral (sum) under the 60 and 120 Hz peaks was used as the value of the LSP at the current spatial position.

When the phosphor screen sample had been placed in the X-radiation generating unit, and the computer program for acquisition has been initiated, the program first set the proper high voltage to the PMT. This allows phosphor screens having various brightnesses to be tested. After the computer had turned on the X-radiation generating unit, but prior to beginning the actual LSP data acquisition, the computer performed a brief data acquisition near the peak region of the LSP so that it can find the actual peak. The computer then positions the translation stage at this peak signal position and adjusted the PMT high voltage to provide peak signal between ½ and full scale of the analog-to-digital converter range. The translation stage was then moved 500 positions away from the peak and data acquisition is begun.

There are 1000 spatial positions, each separated by 10 mμ, at which the value of the LSP was determined. The peak of the LSP was approximated at data point 500. Given that the majority of the LSP data acquired represent baseline, for the first 400 values of the LSP and the last 400 values of the LSP, fewer actual data points were acquired, and the intermediate points (between the actual points) were determined by simple linear interpolation. For each actual data point in these “baseline” regions, the temporal data array was long enough to capture eight repetitions of the single wave rectified X-ray generator waveform. In an effort to minimize errors on the baseline from current bursts in the PMT, a running average value for the baseline was determined and the next data point must fall within some predetermined range of that running average or the acquisition is repeated. For LSP data values 401-600, a data point was acquired at each spatial position. To improve the signal-to-noise in this portion of the LSP, effectively 32 repetitions of the waveform were captured (the average of 4 repeats of the 8 waveform acquisition). At the completion of the acquisition, the PMT high voltage was reduced to zero, the X-radiation generating unit was turned off, and the stage was positioned approximately at data point 500 (the peak of the LSP).

Substantial smoothing of the baseline of the data array was done to aid in subsequent analysis. A mirror analysis was done to assure symmetry to the LSP. This mirror analysis consists of varying the midpoint for the LSP array by amounts less than a full data point spacing, re-sampling the array by interpolation, then calculating the difference between points at mirror positions relative to a given midpoint. The value of the midpoint that gives the minimum difference between left and right is the optimal midpoint. The LSP array was then forced to be symmetric by placing the average value of two mirror points in place of the actual data value for each point in a mirror set. The value of the LSP at the peak position was determined by fitting a parabola to the two points on either side of, the peak position.

After this mirror analysis was completed, the baseline was subtracted. The baseline value removed was determined by averaging values at the beginning and the end of the data array. To eliminate noise in the resulting SSM caused by noise in the baseline data, the baseline data were replaced with an extrapolation of the LSP by fitting an exponential function (least squares method) to the LSP data from 4% down to 1% of the peak value. Then, a Hanning window was applied to the data:
(xₙ′=xₙ[0.5(1−cos(2πn/1000))]).

Finally, the Fourier transform of the LSP was computed. The equation used for this transformation is

$${X}_{k} = \frac{1}{N} {\sum }_{n = 0}^{N - 1} {x}_{n} {ⅇ}^{- 2 πⅈ ( \frac{nk}{N} )}$$

wherein Xₖ represents the modulation at frequency k, and xₙ is the measured LSP at spatial positions n. By the properties of the discrete Fourier Transform, the combination of 1000 data points at a spacing of 10 mμ yielded an array of data after the Fourier Transform that are spaced every 0.1 cycles/mm. The modulation array was normalized to a value of 1.0 at zero spatial frequency. This modulation data gave a measure of the screen sharpness, i.e. the higher the modulation (closer to 1) at higher spatial frequencies, the sharper the image that the phosphor screen can produce. The value of the modulation at selected spatial frequencies is the “Screen Sharpness Measurement” (SSM).

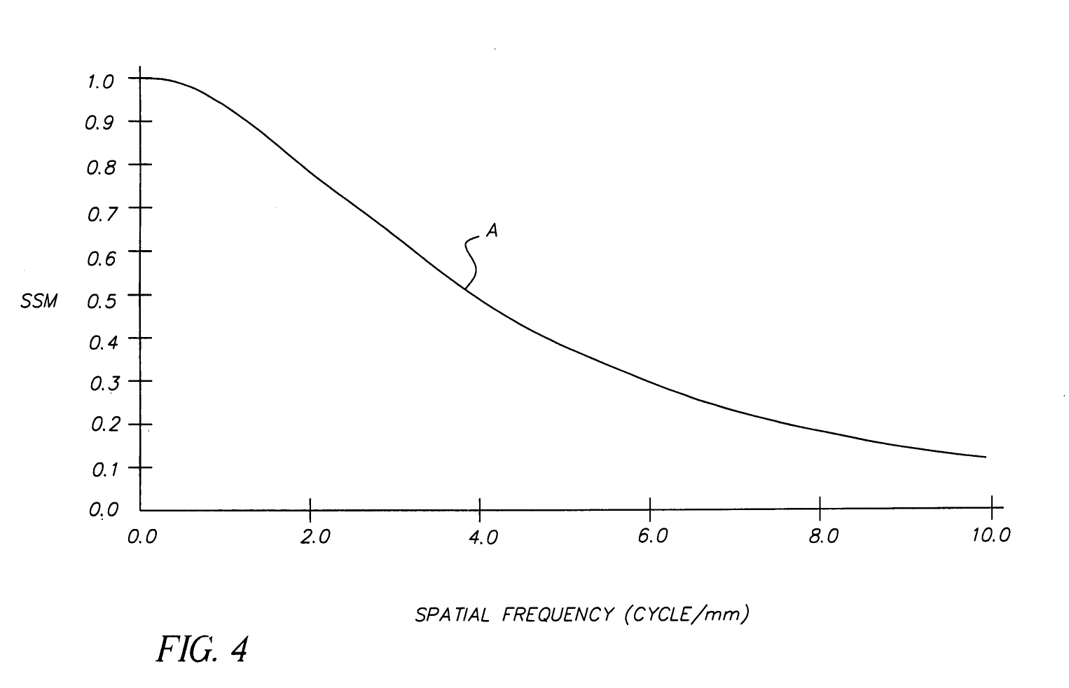

For example, the fluorescent intensifying screens used in the practice of this invention are capable of providing SSM values greater than those represented by reference Curve A of FIG. 4 over the spatial frequency range of from 0 to 10 cycles/mm. TABLE I below lists selected SSM vs. spatial frequency data from which FIG. 4 was generated. Preferred screens used in the practice of this invention are those having SSM values that are at least 1.1 times those represented by reference Curve A of FIG. 4 over a range a spatial frequency range of from 1 to 10 cycles/mm.

TABLE I

| SSM | Spatial Frequency (cycles/mm) |
|---|---|
| 1.000 | 0 |
| 0.982 | 0.5 |
| 0.933 | 1.0 |
| 0.864 | 1.5 |
| 0.786 | 2.0 |
| 0.708 | 2.5 |
| 0.632 | 3.0 |
| 0.563 | 3.5 |
| 0.498 | 4.0 |
| 0.440 | 4.5 |
| 0.388 | 5.0 |
| 0.341 | 5.5 |
| 0.300 | 6.0 |
| 0.264 | 6.5 |
| 0.232 | 7.0 |
| 0.205 | 7.5 |
| 0.181 | 8.0 |
| 0.160 | 8.5 |
| 0.142 | 9.0 |
| 0.125 | 9.5 |
| 0.111 | 10.0 |

The term “dual-coated” is used to define a radiographic film having silver halide emulsion layers disposed on both the front- and backsides of the support. The radiographic silver halide films of the present invention are “dual-coated.”

The radiographic films useful in the present invention are “symmetric” films wherein the silver halide emulsion layers on each side of the support are essentially the same (no compositional differences that provide significant coating or imaging differences).

“Crossover” measurements for “symmetric” radiographic silver halide films of the present invention are obtained by determining the density of the silver developed on each side of the support, both adjacent the intensifying screen and on the opposing side of the support. Densities can be determined using a standard densitometer. By plotting the density produced on each side versus the steps of a conventional step wedge (a measure of exposure), a characteristic sensitometric curve is generated for each side. A higher density is produced for a given exposure of a silver halide emulsion layer that is adjacent the film support. Thus, the two sensitometric curves are offset in speed. At three different density levels in the relatively straight-line portions of the sensitometric curves between the toe and shoulder regions of the curves, the difference in speed (Δlog E) between the two sensitometric curves is measured. These differences were then averaged and used in the following equation to calculate the % crossover:

$$\% Crossover = \frac{1}{antilog ( Δ log E ) + 1} \times 100$$

The term “rapid access processing” is employed to indicate dry-to-dry processing of a radiographic film in 45 seconds or less. That is, 45 seconds or less elapse from the time a dry imagewise exposed radiographic film enters a wet processor until it emerges as a dry fully processed film.

In referring to grains and silver halide emulsions containing two or more halides, the halides are named in order of ascending molar concentrations.

The term “equivalent circular diameter” (ECD) is used to define the diameter of a circle having the same projected area as a silver halide grain. This can be measured using known techniques.

The term “aspect ratio” is used to define the ratio of grain ECD to grain thickness.

The term “coefficient of variation” (COV) is defined as 100 times the standard deviation (a) of grain ECD divided by the mean grain ECD.

The term “fluorescent intensifying screen” refers to a screen that absorbs X-radiation and emits light. A “prompt” emitting fluorescent intensifying screen will emit light immediately upon exposure to radiation while “storage” fluorescent screen can “store” the exposing X-radiation for emission at a later time when the screen is irradiated with other radiation (usually visible light).

The terms “front” and “back” refer to layers, films, or fluorescent intensifying screens nearer to and farther from, respectively, the source of X-radiation.

Research Disclosure is published by Kenneth Mason Publications, Ltd., Dudley House, 12 North St., Emsworth, Hampshire PO10 7DQ England. The publication is also available from Emsworth Design Inc., 147 West 24th Street, New York, N.Y. 10011.

Radiographic Films

The radiographic silver halide films useful in this invention include a flexible support having disposed on both sides thereof, two or more photographic silver halide emulsion layers and optionally one or more non-radiation sensitive hydrophilic layer(s). Thus, the “first” and “second” silver halide emulsion layers are considered to be disposed on the frontside of the support and the “third” and “fourth” silver halide emulsion layers are considered to be disposed on the backside of the support, with the second and fourth silver halide emulsion layers being closer to the support (innermost silver halide emulsion layers) than the first and third silver halide emulsion layers (outermost silver halide emulsion layers).

In many embodiments of the present invention, the photographic silver halide film has two different silver halide emulsion layers on each side of the support and a protective overcoat (described below) over both silver halide emulsion layers on each side of the support. Thus, the first and second silver halide emulsion layers are different and the third and fourth silver halide emulsion layers are different. However, the first and third silver halide emulsion layers have essentially the same composition (for example, components, types of grains, silver halide composition, hydrophilic colloid binder composition, g/m² coverage), and the second and fourth silver halide emulsion layers have essentially the same composition (for example, components, types of grains, silver halide composition, hydrophilic colloid binder composition, g/m² coverage).

The support can take the form of any conventional radiographic film support that is X-radiation and light transmissive. Useful supports for the films of this invention can be chosen from among those described in Research Disclosure, September 1996, Item 38957 XV. Supports and Research Disclosure, Vol. 184, August 1979, Item 18431, XII. Film Supports. The support is preferably a transparent film support. In its simplest possible form the transparent film support consists of a transparent film chosen to allow direct adhesion of the hydrophilic silver halide emulsion layers or other hydrophilic layers. More commonly, the transparent film is itself hydrophobic and subbing layers are coated on the film to facilitate adhesion of the hydrophilic silver halide emulsion layers. Typically the film support is either colorless or blue tinted (tinting dye being present in one or both of the support film and the subbing layers). Polyethylene terephthalate and polyethylene naphthalate are the preferred transparent film support materials.

In the more preferred embodiments, at least one non-light sensitive hydrophilic layer is included with the one or more silver halide emulsion layers on each side of the film support. This layer may be an interlayer or overcoat, or both types of non-light sensitive layers can be present.

The first, second, third, and fourth silver halide emulsion layers comprise predominantly (more than 50%, and preferably at least 70%, of the total grain projected area) tabular silver halide grains. The grain composition can vary among the layers, but preferably, the grain composition is essentially the same in the first and third silver halide emulsion layers and independently, it is essentially the same in the second and fourth silver halide emulsion layers. More preferably, the grain composition is essentially the same in all four emulsion layers. These tabular silver halide grains generally comprise at least 90, preferably at least 95, and more preferably at least 98, mol % bromide, based on total silver in the emulsion layer. Such emulsions include silver halide grains composed of, for example, silver iodobromide, silver chlorobromide, silver iodochlorobromide, and silver chloroiodobromide. The iodide grain content is generally up to 3 mol %, based on total silver in the emulsion layer. Preferably the iodide grain content is up to 2 mol %, and more preferably up to about 0.5 mol % (based on total silver in the emulsion layer). Mixtures of different tabular silver halide grains can be used in any of the silver halide emulsion layers.

Any of the silver halide emulsion layers can also include some non-tabular silver halide grains having any desirable non-tabular morphology, or be comprised of a mixture of two or more of such morphologies. The composition and methods of making such silver halide grains are well known in the art.

The tabular silver halide grains used in the first, second, third, and fourth silver halide emulsion layers independently have as aspect ratio of at least 35, and preferably of from about 40 to about 50. The aspect ratio can be the same or different in the four silver halide emulsion layers, but preferably, the tabular grains have essentially the same aspect ratio in all four silver halide emulsion layers.

In general, the tabular grains in any of the silver halide emulsion layers have an average grain diameter (ECD) of at least 3.0 μm, and preferably of at least 4.0 μm. The average grain diameters can be the same or different in the various emulsion layers. At least 100 non-overlapping tabular grains are measured to obtain the “average” ECD.

In addition, the tabular grains in the first, second, third, and fourth silver halide emulsion layers independently have an average thickness of from about 0.08 to about 0.12 μm, and preferably from about 0.09 to about 0.11 μm. Preferably, the average grain thickness is essentially the same for all four emulsion layers.

The procedures and equipment used to determine tabular grain size (and aspect ratio) are well known in the art. Tabular grain emulsions that have the desired composition and sizes are described in greater detail in the following patents, the disclosures of which are incorporated herein by reference:

U.S. Pat. No. 4,414,310 (Dickerson), U.S. Pat. No. 4,425,425 (Abbott et al.), U.S. Pat. No. 4,425,426 (Abbott et al.), U.S. Pat. No. 4,439,520 (Kofron et al.), U.S. Pat. No. 4,434,226 (Wilgus et al.), U.S. Pat. No. 4,435,501 (Maskasky), U.S. Pat. No. 4,713,320 (Maskasky), U.S. Pat. No. 4,803,150 (Dickerson et al.), U.S. Pat. No. 4,900,355 (Dickerson et al.), U.S. Pat. No. 4,994,355 (Dickerson et al.), U.S. Pat. No. 4,997,750 (Dickerson et al.), U.S. Pat. No. 5,021,327 (Bunch et al.), U.S. Pat. No. 5,147,771 (Tsaur et al.), U.S. Pat. No. 5,147,772 (Tsaur et al.), U.S. Pat. No. 5,147,773 (Tsaur et al.), U.S. Pat. No. 5,171,659 (Tsaur et al.), U.S. Pat. No. 5,252,442 (Dickerson et al.), U.S. Pat. No. 5,370,977 (Zietlowj, U.S. Pat. No. 5,391,469 (Dickerson), U.S. Pat. No. 5,399,470 (Dickerson et al.), U.S. Pat. No. 5,411,853 (Maskasky), U.S. Pat. No. 5,418,125 (Maskasky), U.S. Pat. No. 5,494,789 (Daubendiek et al.), U.S. Pat. No. 5,503,970 (Olm et al.), U.S. Pat. No. 5,536,632 (Wen et al.), U.S. Pat. No. 5,518,872 (King et al.), U.S. Pat. No. 5,567,580 (Fenton et al.), U.S. Pat. No. 5,573,902 (Daubendiek et al.), U.S. Pat. No. 5,576,156 (Dickerson), U.S. Pat. No. 5,576,168 (Daubendiek et al.), U.S. Pat. No. 5,576,171 (Olm et al.), and U.S. Pat. No. 5,582,965 (Deaton et al.).

The silver halide emulsion layers on opposite sides of the support can have the same general dry unprocessed thickness and coating weight, but preferably, the two silver halide emulsion layers on each side have different dry thickness. It is preferable that the outermost silver halide emulsion layers be thicker than the silver halide emulsion layers closer to the support. These evaluations are made on the dried film before it is contacted with processing solutions. Thus, the dry, unprocessed thickness ratio of the first silver halide emulsion layer to that of the second silver halide emulsion layer is greater than 1:1 (preferably from about 3:1 to about 1:1), and the dry, unprocessed thickness ratio of the third silver halide emulsion layer to that of the fourth silver halide emulsion layer is independently greater than 1:1 (preferably from about 3:1 to about 1:1).

In addition, the silver halide emulsion layers closer to the support on both sides (that is the second and fourth silver halide emulsion layers) comprise one or more “crossover control agents” that are present in sufficient amounts to reduce light transmitted through the support to opposing layers to less than 10% and preferably less than 8%. Crossover is measured in the practice of this invention as noted above.

Useful crossover control agents are well known in the art and include one or more compounds that provide a total density of at least 0.3 (preferably at least 0.45) and up to 0.9 at a preferred wavelength of 545 nm and that are disposed on a transparent support. The density can be measured using a standard densitometer (using “visual status”). In general, the amount of crossover control agent in the “second” silver halide emulsion layer will vary depending upon the strength of absorption of the given compound(s), but for most pigments and dyes, the amount is generally from about 0.75 to about 1.5 mg/m² (preferably from about 1 mg to about 1.3 mg/m²).

In addition, the crossover control agents must be substantially removed within 90 seconds (preferably with 45 seconds) during processing (generally during development). By “substantially” means that the crossover control agent remaining in the film after processing provides no more than 0.05 optical density as measured using a conventional sensitometer. Removal of the crossover control agents can be achieved by their migration out of the film, but preferably, they are not physically removed but are decolorized during processing.

Pigments and dyes that can be used as crossover control agents include various water-soluble, liquid crystalline, or particulate magenta or yellow filter dyes or pigments including those described for example in U.S. Pat. No. 4,803,150 (Dickerson et al.), U.S. Pat. No. 5,213,956 (Diehl et al.), U.S. Pat. No. 5,399,690 (Diehl et al.), U.S. Pat. No. 5,922,523 (Helber et al.), U.S. Pat. No. 6,214,499 (Helber et al.), and Japanese Kokai 2-123349, all of which are incorporated herein by reference for pigments and dyes useful in the practice of this invention. One useful class of particulate dyes useful as crossover control agents includes nonionic polymethine dyes such as merocyanine, oxonol, hemioxonol, styryl, and arylidene dyes as described in U.S. Pat. No. 4,803,150 (noted above) that is incorporated herein for the definitions of those dyes. The particulate magenta merocyanine and oxonol dyes are preferred and the magenta oxonol dyes are most preferred.

One particularly useful magenta oxonol dye that can be used as a crossover control agent is the following compound M-1:

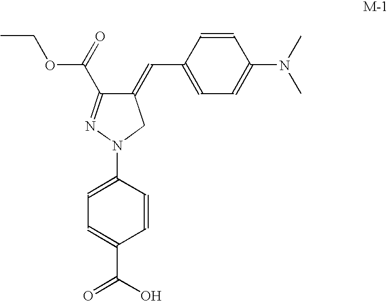

A variety of silver halide dopants can be used, individually and in combination, in one or more of the silver halide emulsion layers to improve contrast as well as other common sensitometric properties. A summary of conventional dopants is provided by Research Disclosure, Item 38957, cited above, Section I. Emulsion grains and their preparation, sub-section D. Grain modifying conditions and adjustments, paragraphs (3), (4), and (5).

A general summary of silver halide emulsions and their preparation is provided by Research Disclosure, Item 38957, cited above, Section I. Emulsion grains and their preparation. After precipitation and before chemical sensitization the emulsions can be washed by any convenient conventional technique using techniques disclosed by Research Disclosure, Item 38957, cited above, Section III. Emulsion washing.

Any of the emulsions can be chemically sensitized by any convenient conventional technique as illustrated by Research Disclosure, Item 38957, Section IV. Chemical Sensitization: Sulfur, selenium or gold sensitization (or any combination thereof) are specifically contemplated. Sulfur sensitization is preferred, and can be carried out using for example, thiosulfates, thiosulfonates, thiocyanates, isothiocyanates, thioethers, thioureas, cysteine, or rhodanine. A combination of gold and sulfur sensitization is most preferred.

In addition, if desired, any of the silver halide emulsions can include one or more suitable spectral sensitizing dyes that include, for example, cyanine and merocyanine spectral sensitizing dyes. The useful amounts of such dyes are well known in the art but are generally within the range of from about 200 to about 1000 mg/mole of silver in the given emulsion layer. It is particularly preferred that all of the tabular silver halide grains used in the present invention (in all silver halide emulsion layers) be “green-sensitized”, that is spectrally sensitized to radiation of from about 470 to about 570 nm of the electromagnetic spectrum. Various spectral sensitizing dyes are known for achieving this characteristic.

Instability that increases minimum density in negative-type emulsion coatings (that is fog) can be protected against by incorporation of stabilizers, antifoggants, antikinking agents, latent-image stabilizers and similar addenda in the emulsion and contiguous layers prior to coating. Such addenda are illustrated by Research Disclosure, Item 38957, Section VII. Antifoggants and stabilizers, and Item 18431, Section II: Emulsion Stabilizers, Antifoggants and Antikinking Agents.

It may also be desirable that one or more silver halide emulsion layers include one or more covering power enhancing compounds adsorbed to surfaces of the silver halide grains. A number of such materials are known in the art, but preferred covering power enhancing compounds contain at least one divalent sulfur atom that can take the form of a —S— or ═S moiety. Such compounds are described in U.S. Pat. No. 5,800,976 (Dickerson et al.) that is incorporated herein by reference for the teaching of such sulfur-containing covering power enhancing compounds.

The silver halide emulsion layers and other hydrophilic layers on both sides of the support of the radiographic films generally contain conventional polymer vehicles (peptizers and binders) that include both synthetically prepared and naturally occurring colloids or polymers. The most preferred polymer vehicles include gelatin or gelatin derivatives alone or in combination with other vehicles. Conventional gelatino-vehicles and related layer features are disclosed in Research Disclosure, Item 38957, Section II. Vehicles, vehicle extenders, vehicle-like addenda and vehicle related addenda. The emulsions themselves can contain peptizers of the type set out in Section II, paragraph A. Gelatin and hydrophilic colloid peptizers. The hydrophilic colloid peptizers are also useful as binders and hence are commonly present in much higher concentrations than required to perform the peptizing function alone. The preferred gelatin vehicles include alkali-treated gelatin, acid-treated gelatin or gelatin derivatives (such as acetylated gelatin, deionized gelatin, oxidized gelatin and phthalated gelatin). Cationic starch used as a peptizer for tabular grains is described in U.S. Pat. No. 5,620,840 (Maskasky) and U.S. Pat. No. 5,667,955 (Maskasky). Both hydrophobic and hydrophilic synthetic polymeric vehicles can be used also. Such materials include, but are not limited to, polyacrylates (including polymethacrylates), polystyrenes and polyacrylamides [including poly(methacrylamides)]. Dextrans can also be used. Examples of such materials are described for example in U.S. Pat. No. 5,876,913 (Dickerson et al.), incorporated herein by reference.

Thin, high aspect ratio tabular grain silver halide emulsions useful in the present invention will typically be prepared by processes including nucleation and subsequent growth steps. During nucleation, silver and halide salt solutions are combined to precipitate a population of silver halide nuclei in a reaction vessel. Double jet (addition of silver and halide salt solutions simultaneously) and single jet (addition of one salt solution, such as a silver salt solution, to a vessel already containing an excess of the other salt) process are known. During the subsequent growth step, silver and halide salt solutions, and/or preformed fine silver halide grains, are added to the nuclei in the reaction vessel, and the added silver and halide combines with the existing population of grain nuclei to form larger grains. Control of conditions for formation of high aspect ratio tabular grain silver bromide and iodobromide emulsions is known, e.g., based upon (Wilgus et al.) U.S. Pat. No. 4,434,226, (Solberg et al.) U.S. Pat. No. 4,433,048 and (Kofron et al.) U.S. Pat. No. 4,439,520. It is recognized, e.g., that the bromide ion concentration in solution at the stage of grain formation must be maintained within limits to achieve the desired tabularity of grains. As grain growth continues, the bromide ion concentration in solution becomes progressively less influential on the grain shape ultimately achieved. For example, Wilgus et al U.S. Pat. No. 4,434,226, e.g., teaches the precipitation of high aspect ratio tabular grain silver bromoiodide emulsions at bromide ion concentrations in the pBr range of from 0.6 to 1.6 during grain nucleation, with the pBr range being expanded to 0.6 to 2.2 during subsequent grain growth. (Kofron et al.) U.S. Pat. No. 4,439,520 extends these teachings to the precipitation of high aspect ratio tabular grain silver bromide emulsions. pBr is defined as the negative log of the solution bromide ion concentration. (Daubendiek et al.) U.S. Pat. No. 4,414,310 describes a process for the preparation of high aspect ratio silver bromoiodide emulsions under pBr conditions not exceeding the value of 1.64 during grain nucleation. (Maskasky) U.S. Pat. No. 4,713,320 in the preparation of high aspect ratio silver halide emulsions, teaches that the useful pBr range during nucleation can be extended to a value of 2.4 when the precipitation of the tabular silver bromide or bromoiodide grains occurs in the presence of gelatino-peptizer containing less than 30 micromoles of methionine (e.g., oxidized gelatin) per gram. The use of such oxidized gel also enables the preparation of thinner and/or larger diameter grains, and/or more uniform grain populations containing fewer non-tabular grains.

The use of oxidized gelatin as peptizer during nucleation, such as taught by U.S. Pat. No. 4,713,320, is particularly preferred for making thin, high aspect ratio tabular grain emulsions for use in the present invention, employing either double or single jet nucleation processes. As gelatin employed as peptizer during nucleation typically will comprise only a fraction of the total gelatin employed in an emulsion, the percentage of oxidized gelatin in the resulting emulsion may be relatively small, that is, at least 0.25% (based on total dry weight).

Thus it is preferred that the coated first, second, third, and fourth tabular grain silver halide emulsion layers comprise tabular silver halide grains dispersed in a hydrophilic polymeric vehicle mixture comprising at least 0.25% and preferably at least 0.35% of oxidized gelatin based on the total dry weight of polymeric vehicle mixture in that coated emulsion layer. The upper limit for the oxidized gelatin is not critical but for practical purposes it is 1.5% based on the total dry weight of the polymer vehicle mixture. Preferably, from about 0.4 to about 0.6% (by dry weight) of the polymer vehicle mixture is oxidized gelatin. The amount of oxidized gelatin in the emulsion layers can be the same or different. Preferably, it is the same amount in all four emulsion layers.

It is also preferred that the oxidized gelatin be in the form of deionized oxidized gelatin but non-deionized oxidized gelatin can be used, or a mixture of deionized and non-deionized oxidized gelatins can be used. Deionized or non-deionized oxidized gelatin generally has the property of relatively lower amounts of methionine per gram of gelatin than other forms of gelatin. Preferably, the amount of methionine is from 0 to about 3 μmol of methionine, and more preferably from 0 to 1 μmol of methionine, per gram of gelatin. This material can be prepared using known procedures.

The remainder of the polymeric vehicle mixture can be any of the hydrophilic vehicles described above, but preferably it is composed of alkali-treated gelatin, acid-treated gelatin acetylated gelatin, or phthalated gelatin.

The silver halide emulsions containing the tabular silver halide grains described above can be prepared as noted using a considerable amount of oxidized gelatin (preferably deionized oxidized gelatin) during grain nucleation and growth, and then additional polymeric binder can be added to provide the coating formulation. The amounts of oxidized gelatin in the emulsion can be as low as 0.3 g/mol of silver and as high as 27 g/mol of silver in the emulsion. Preferably, the amount of oxidized gelatin in the emulsion is from about 1 to about 20 g/mol of silver.

The silver halide emulsion layers (and other hydrophilic layers) in the radiographic films are generally fully hardened using one or more conventional hardeners. Thus, the amount of hardener on each side of the support is generally at least 1.5% and preferably at least 2%, based on the total dry weight of the polymer vehicles on each side of the support.

The levels of silver and polymer vehicle in the radiographic silver halide film useful in the present invention can vary in the various silver halide emulsion layers. In general, the total amount of silver on each side of the support is at least 18 and no more than 24 mg/dm². In addition, the total coverage of polymer vehicle on each side of the support is generally at least 30 and no more than 40 mg/dm². The amounts of silver and polymer vehicle on the two sides of the support in the radiographic silver halide film can be the same or different. These amounts refer to dry weights.

In addition, the molar ratio of silver in the first silver halide emulsion layer to that of the second silver halide emulsion layer is greater than 1:1 (preferably from about 1.5:1 to about 3:1), and the molar ratio of silver in the third silver halide emulsion layer to that of the fourth silver halide emulsion layer is independently greater than 1:1 (preferably from about 1.5:1 to about 3:1).

The radiographic silver halide films useful in this invention generally include a surface protective overcoat disposed on each side of the support that typically provides for physical protection of the various layers underneath. Each protective overcoat can be sub-divided into two or more individual layers. For example, protective overcoats can be sub-divided into surface overcoats and interlayers (between the overcoat and silver halide emulsion layers). In addition to vehicle features discussed above the protective overcoats can contain various addenda to modify the physical properties of the overcoats. Such addenda are illustrated by Research Disclosure, Item 38957, Section IX. Coating physical property modifying addenda, A. Coating aids, B. Plasticizers and lubricants, C. Antistats, and D. Matting agents. Interlayers that are typically thin hydrophilic colloid layers can be used to provide a separation between the silver halide emulsion layers and the surface overcoats or between the silver halide emulsion layers. The overcoat on at least one side of the support can also include a blue toning dye or a tetraazaindene (such as 4-hydroxy-6-methyl-1,3,3a,7-tetraazaindene) if desired.

The protective overcoat is generally comprised of one or more hydrophilic colloid vehicles, chosen from among the same types disclosed above in connection with the emulsion layers.

The various coated layers of radiographic silver halide films can also contain tinting dyes to modify the image tone to transmitted or reflected light. These dyes are not decolorized during processing and may be homogeneously or heterogeneously dispersed in the various layers. Preferably, such non-bleachable tinting dyes are in a silver halide emulsion layer.

Imaging Assemblies

The radiographic imaging assemblies of the present invention are composed of one radiographic silver halide film as described herein and one or more fluorescent intensifying screens. Usually, two fluorescent intensifying screen are used, one on the “frontside” and the other on the “backside” of the film. Fluorescent intensifying screens are typically designed to absorb X-rays and to emit electromagnetic radiation having a wavelength greater than 300 nm. These screens can take any convenient form providing they meet all of the usual requirements for use in radiographic imaging. Examples of conventional, useful fluorescent intensifying screens are provided by Research Disclosure, Item 18431, cited above, Section IX. X-Ray Screens/Phosphors, and U.S. Pat. No. 5,021,327 (Bunch et al.), U.S. Pat. No. 4,994,355 (Dickerson et al.), U.S. Pat. No. 4,997,750 (Dickerson et al.), and U.S. Pat. No. 5,108,881 (Dickerson et al.), the disclosures of which are here incorporated by reference. The fluorescent layer contains phosphor particles and a binder, optimally additionally containing a light scattering material, such as titania.

Any conventional or useful phosphor can be used, singly or in mixtures, in the intensifying screens used in the practice of this invention. For example, useful phosphors are described in numerous references relating to fluorescent intensifying screens, including but not limited to, Research Disclosure, Vol. 184, August 1979, Item 18431, Section IX, X-ray Screens/Phosphors, and U.S. Pat. No. 2,303,942 (Wynd et al.), U.S. Pat. No. 3,778,615 (Luckey), U.S. Pat. No. 4,032,471 (Luckey), U.S. Pat. No. 4,225,653 (Brixner et al.), U.S. Pat. No. 3,418,246 (Royce), U.S. Pat. No. 3,428,247 (Yocon), U.S. Pat. No. 3,725,704 (Buchanan et al.), U.S. Pat. No. 2,725,704 (Swindells), U.S. Pat. No. 3,617,743 (Rabatin), U.S. Pat. No. 3,974,389 (Ferri et al.), U.S. Pat. No. 3,591,516 (Rabatin), U.S. Pat. No. 3,607,770 (Rabatin), U.S. Pat. No. 3,666,676 (Rabatin), U.S. Pat. No. 3,795,814 (Rabatin), U.S. Pat. No. 4,405,691 (Yale), U.S. Pat. No. 4,311,487 (Luckey et al.), U.S. Pat. No. 4,387,141 (Patten), U.S. Pat. No. 5,021,327 (Bunch et al.), U.S. Pat. No. 4,865,944 (Roberts et al.), U.S. Pat. No. 4,994,355 (Dickerson et al.), U.S. Pat. No. 4,997,750 (Dickerson et al.), U.S. Pat. No. 5,064,729 (Zegarski), U.S. Pat. No. 5,108,881 (Dickerson et al.), U.S. Pat. No. 5,250,366 (Nakajima et al.), U.S. Pat. No. 5,871,892 (Dickerson et al.), EP 0 491,116A1 (Benzo et al.), the disclosures of all of which are incorporated herein by reference with respect to the phosphors.

For example, the inorganic phosphor can be calcium tungstate, activated or unactivated lithium stannates, niobium and/or rare earth activated or unactivated yttrium, lutetium, or gadolinium tantalates, rare earth-activated or unactivated middle chalcogen phosphors such as rare earth oxychalcogenides and oxyhalides, or terbium-activated or unactivated lanthanum or lutetium middle chalcogen phosphor, or the inorganic phosphor can contain hafnium.

Alternatively, the inorganic phosphor is a rare earth oxychalcogenide and. oxyhalide phosphor that is represented by the following formula (1):
M′_{(w-n)}M″ₙO_{w}X′ (1)
wherein M′ is at least one of the metals yttrium (Y), lanthanum (La), gadolinium (Gd), or lutetium (Lu), M″ is at least one of the rare earth metals, preferably dysprosium (Dy), erbium (Er), europium (Eu), holmium (Ho), neodymium (Nd), praseodymium (Pr), samarium (Sm), tantalum (Ta), terbium (Th), thulium (Tm), or ytterbium (Yb), X′ is a middle chalcogen (S, Se, or Te) or halogen, n is 0.002 to 0.2, and w is 1 when X′ is halogen or 2 when X′ is a middle chalcogen.

Particularly preferred phosphors of formula (1) include a lanthanum oxybromides, or terbium-activated or thulium-activated gadolinium oxides.

In other embodiments, the inorganic phosphor is an alkaline earth metal phosphor that is the product of firing starting materials comprising optional oxide and a combination of species characterized by the following formula (2):
MFX_{1-z}I_{z}uM^{a}X^{a}:yA:eQ:tD (2)
wherein “M” is magnesium (Mg), calcium (Ca), strontium (Sr), or barium (Ba), “F” is fluoride, “X” is chloride (Cl) or bromide (Br), “I” is iodide, Ma is sodium (Na), potassium (K), rubidium (Rb), or cesium (Cs), Xa is fluoride (F), chloride (Cl), bromide (Br), or iodide (I), “A” is europium (Eu), cerium (Ce), samarium (Sm), or terbium (Th), “Q” is BeO, MgO, CaO, SrO, BaO, ZnO, Al₂O₃, La₂O₃, In₂O₃, SiO₂, TiO₂, ZrO₂, GeO₂, SnO₂, Nb₂O₅, Ta₂O₅, or ThO₂, “D” is vanadium (V), chromium (Cr), manganese (Mn), iron (Fe), cobalt (Co), or nickel (Ni), “z” is 0 to 1, “u” is from 0 to 1, “y” is from 1×10⁻⁴ to 0.1, “e” is form 0 to 1, and “t” is from 0 to 0.01.

In preferred embodiments, the coverage of the inorganic phosphor in the phosphor layer is from about 3.2 to about 3.8 g/dm² at a phosphor to binder weight ratio of from about 20:1 to about 22:1. A particularly useful phosphor is a terbium activated gadolinium oxysulfide phosphor and a particularly useful fluorescent intensifying screen of containing this phosphor layer is Kodak MinR-2190® that is available from Eastman Kodak Company and is described in general as Screen W in the Example below. This screen can be prepared using components and procedures known by one skilled in the art.

A skilled worker in the art would be able to choose the appropriate inorganic phosphor, its particle size, and coverage in the phosphor layer to provide a photographic speed of the fluorescent intensifying screen of at least 150.

The radiographic silver halide film and the fluorescent intensifying screen(s) can be arranged in a suitable “cassette” designed for this purpose and well known in the art.

Imaging and Processing

Exposure and processing of the radiographic silver halide films useful in this invention can be undertaken in any convenient conventional manner. The exposure and processing techniques of U.S. Pat. No. 5,021,327 and U.S. Pat. No. 5,576,156 (both noted above) are typical for processing radiographic films. Other processing compositions (both developing and fixing compositions) are described in U.S. Pat. No. 5,738,979 (Fitterman et al.), U.S. Pat. No. 5,866,309 (Fitterman et al.), U.S. Pat. No. 5,871,890 (Fitterman et al.), U.S. Pat. No. 5,935,770 (Fitterman et al.), U.S. Pat. No. 5,942,378 (Fitterman et al.), all incorporated herein by reference. The processing compositions can be supplied as single- or multi-part formulations, and in concentrated form or as more diluted working strength solutions.

Exposing X-radiation is generally directed through a patient and through a fluorescent intensifying screen arranged against the frontside of the film before it passes through the radiographic silver halide film, and the second fluorescent intensifying screen.

It is particularly desirable that the radiographic silver halide films be processed within 90 seconds (“dry-to-dry”) and preferably at least 20 seconds and up to 60 seconds, including the developing, fixing and any washing (or rinsing) steps, before drying. Such processing can be carried out in any suitable processing equipment including but not limited to, a Kodak X-OMAT® RA 480 processor that can utilize Kodak Rapid Access processing chemistry. Other “rapid access processors” are described for example in U.S. Pat. No. 3,545,971 (Barnes et al.) and EP 0 248,390A1 (Akio et al.). Preferably, the black-and-white developing compositions used during processing are free of any photographic film hardeners, such as glutaraldehyde.

Radiographic kits can include an imaging assembly of this invention, additional radiographic silver halide films, one or more additional fluorescent intensifying screens and/or metal screens, and/or one or more suitable processing compositions (for example black-and-white developing and fixing compositions).

The following example is presented for illustration and the invention is not to be interpreted as limited thereby.

Example:

Radiographic Film A (Control):

Radiographic Film A was a dual-coated film having the same silver halide emulsion on each side of a blue-tinted 170 μm transparent poly(ethylene terephthalate) film support and an interlayer and overcoat layer over each emulsion layer. The emulsions in Film A were not prepared using oxidized gelatin.

Radiographic Film A had the following layer arrangement:

Overcoat

Interlayer

Emulsion Layer

Support

Emulsion Layer

Interlayer

Overcoat

The noted layers were prepared from the following formulations.

| | Coverage (mg/dm²) |
|---|---|
| Overcoat Formulation | |
| Gelatin vehicle | 3.4 |
| Methyl methacrylate matte beads | 0.14 |
| Carboxymethyl casein | 0.57 |
| Colloidal silica (LUDOX AM) | 0.57 |
| Polyacrylamide | 0.57 |
| Chrome alum | 0.025 |
| Resorcinol | 0.058 |
| Spermafol | 0.15 |
| Interlayer Formulation | |
| Gelatin vehicle | 3.4 |
| Carboxymethyl casein | 0.57 |
| Colloidal silica (LUDOX AM) | 0.57 |
| Polyacrylamide | 0.57 |
| Chrome alum | 0.025 |
| Resorcinol | 0.058 |
| Nitron | 0.044 |
| Emulsion Layer Formulation | |
| Tabular grain emulsion | 16.1 |
| [AgBr 2.9 μm ave. dia. × 0.10 μm thickness] | |
| Gelatin vehicle | 26.3 |
| 4-Hydroxy-6-methyl-1,3,3a,7- | 2.1 g/Ag mole |
| tetraazaindene | |
| Potassium nitrate | 1.8 |
| Maleic acid hydrazide | 0.0087 |
| Sorbitol | 0.53 |
| Glycerin | 0.57 |
| Potassium bromide | 0.14 |
| Resorcinol | 0.44 |
| Bisvinylsulfonylmethane | 2% based on total |
| | gelatin in all layers |
| | on same side |

Radiographic Film B (Invention):

Radiographic Film B was dual-coated, symmetric radiographic film with two different silver halide emulsion layers on each side of the support. The two emulsion layers contained tabular silver halide grains that were prepared and dispersed in deionized oxidized gelatin that had been added at multiple times before and/or during the nucleation and early growth of the silver bromide tabular grains dispersed therein. The tabular grains in each silver halide emulsion layer had a mean aspect ratio of about 20. The nucleation and early growth of the tabular grains were performed using a “bromide-ion-concentration free-fall”process in which a dilute silver nitrate solution was slowly added to a bromide ion-rich deionized oxidized gelatin environment. The grains were chemically sensitized with sulfur, gold, and selenium using conventional procedures. Spectral sensitization to about 560 nm was provided using anhydro-5,5-dichloro-9-ethyl-3,3′-bis(3-sulfopropyl)oxacarbocyanine hydroxide (680 mg/mole of silver) followed by potassium iodide (400 mg/mole of silver).

Film B had the following layer arrangement and formulations on the film support:

Overcoat

Interlayer

Emulsion Layer 1

Emulsion Layer 2

Support

Emulsion Layer 2

Emulsion Layer 1

Interlayer

Overcoat

| | Coverage (mg/dm²) |
|---|---|
| Overcoat Formulation | |
| Gelatin vehicle | 3.4 |
| Methyl methacrylate matte beads | 0.14 |
| Carboxymethyl casein | 0.57 |
| Colloidal silica (LUDOX AM) | 0.57 |
| Polyacrylamide | 0.57 |
| Chrome alum | 0.025 |
| Resorcinol | 0.058 |
| Spermafol | 0.15 |
| Interlayer Formulation | |
| Gelatin vehicle | 3.4 |
| Carboxymethyl casein | 0.57 |
| Colloidal silica (LUDOX AM) | 0.57 |
| Polyacrylamide | 0.57 |
| Chrome alum | 0.025 |
| Resorcinol | 0.058 |
| Nitron | 0.044 |
| Emulsion Layer 1 Formulation | |
| Tabular grain emulsion | 12.9 |
| [AgBr 4 μm ave. dia. × 0.25 μm thickness] | |
| Gelatin vehicle | 17.2 |
| 4-Hydroxy-6-methyl-1,3,3a,7- | 2.1 g/Ag mole |
| tetraazaindene | |
| Potassium nitrate | 1.8 |
| Ammonium hexachloropalladate | 0.0022 |
| Maleic acid hydrazide | 0.0087 |
| Sorbitol | 0.53 |
| Glycerin | 0.57 |
| Potassium bromide | 0.14 |
| Resorcinol | 0.44 |
| Emulsion Layer 2 Formulation | |
| Tabular grain emulsion | 6.5 |
| [AgBr 4 μm ave. dia. × 0.85 μm thickness] | |
| Gelatin vehicle | 8.6 |
| Microcrystalline Dye M-1 (shown above) | 1.08 |
| 5-Bromo-4-hydroxy-6-methyl-1,3,3a,7- | 0.7 g/Ag mole |
| tetraazaindene | |
| Potassium nitrate | 1.1 |
| Ammonium hexachloropalladate | 0.013 |
| Maleic acid hydrazide | 0.0053 |
| Sorbitol | 0.32 |
| Glycerin | 0.35 |
| Potassium bromide | 0.083 |
| Resorcinol | 0.26 |
| Bisvinylsulfonylmethane | 2% based on |
| | total gelatin on |
| | same side |

The cassettes used for imaging contained two of the following screens, one on either side of the noted radiographic films:

Fluorescent intensifying screen “X” was commercially available KODAK Lanex® Regular Screen. It comprised a terbium activated gadolinium oxysulfide phosphor (median particle size of 7.8 to 8 μm) dispersed in a Permuthane™ polyurethane binder on a white-pigmented poly(ethylene terephthalate) film support. The total phosphor coverage was 4.83 g/dm² and the phosphor to binder weight ratio was 19:1.

Fluorescent intensifying screen “W” was commercially available Kodak MinR-2190® Screen. It comprised a terbium activated gadolinium oxysulfide phosphor (median particle size of from 3.8 to 4 μm) dispersed in a Permuthane™ polyurethane binder on a white-pigmented poly(ethylene terephthalate) film support. The total phosphor coverage was 3.4 g/dm² and the phosphor to binder weight ratio was 21:1. This screen also includes 27 ppm of carbon.

Fluorescent intensifying screen “Z” was commercially available Kodak Lanex® Fine Screen. It comprised a terbium activated gadolinium oxysulfide phosphor (median particle size of 3.8 to 4 μm) dispersed in a Permuthane® polyurethane binder on a white-pigmented poly(ethylene terephthalate) film support. The total phosphor coverage was 3.4 g/dm² and the phosphor to binder weight ratio was 21:1.

Samples of the films in the imaging assemblies were exposed using an inverse square X-ray sensitometer (device that makes exceedingly reproducible X-ray exposures). A lead screw moved the detector between exposures. By use of the inverse square law, distances were selected that produced exposures that differed by 0.1 Log E. The length of the exposures was constant. This instrument provided sensitometry that gives the response of the detector to an imagewise exposure where all of the image is exposed for the same length of time, but the intensity is changed due to the anatomy transmitting more or less of the X-radiation flux.

The exposed film samples were processed using a commercially available KODAK RP X-OMAT® Film Processor M6A-N, M6B, or M35A. Development was carried out using the following black-and-white developing composition:

| | |
|---|---|
| Hydroquinone | 30 g |
| Phenidone | 1.5 g |
| Potassium hydroxide | 21 g |
| NaHCO₃ | 7.5 g |
| K₂SO₃ | 44.2 g |
| Na₂S₂O₅ | 12.6 g |
| Sodium bromide | 35 g |
| 5-Methylbenzotriazole | 0.06 g |
| Glutaraldehyde | 4.9 g |
| Water to 1 liter, pH 10 | |

Fixing was carried out using KODAK RP X-OMAT® LO Fixer and Replenisher fixing composition (Eastman Kodak Company). The film samples were processed in each instance for less than 90 seconds (dry-to-dry).

Optical densities are expressed below in terms of diffuse density as measured by a conventional X-rite™ Model 310 densitometer that was calibrated to ANSI standard PH 2.19 and was traceable to a National Bureau of Standards calibration step tablet. The characteristic density vs. log E curve was plotted for each radiographic film that was exposed and processed as noted above. System speed and % crossover were measured as described above. SSM data for the screens were determined as described above. Only the SSM values at 2 cycles/mm are reported in TABLE II but FIG. 4 shows the SSM data over the entire range of spatial frequencies for Screen W in an imaging assembly of the present invention.

The following TABLE II shows the sensitometric data of Films A and B when exposed with various screens. The data show that sharp images can be obtained with Film A when it is combined with screens having higher SSM values. However, the system speed of the overall imaging assembly is reduced by almost 400%. When Film B was combined with Screen W, there was no system speed loss (compared to the use of Film A) and a higher SSM value was provided.

Thus, the imaging assemblies of the present invention provided sharper images without the need to increase patient exposure to X-radiation (dosage).

TABLE I

| | | System | Film | Cross- | Con- | SSM @ 2 |
|---|---|---|---|---|---|---|
| Film | Screen | Speed | Speed | over | trast | cycles/mm |
| A (Control) | X | 400 | 400 | 21% | 2.9 | 0.49 |
| A (Control) | W | 196 | 400 | 21% | 2.9 | 0.79 |
| A (Control) | Z | 137 | 400 | 21% | 2.9 | 0.83 |
| B (Control) | X | 826 | 800 | 8% | 3.1 | 0.49 |
| B (Invention) | W | 406 | 800 | 8% | 3.1 | 0.79 |
| B (Control) | Z | 233 | 800 | 8% | 3.1 | 0.83 |

The invention has been described in detail with particular reference to preferred embodiments thereof, but it will be understood that variations and modifications can be effected within the spirit and scope of the invention.

### Parts list

10 slit-shaped x-ray exposure

15 phosphor screen sample

20 optical slit

25 X-ray slit (or mask)

30 photomultiplier tube (pmt)

35 integrating sphere

45 profile or spread

1. A radiographic imaging assembly that has a system speed of at least 400 and comprises:
A) a symmetric radiographic silver halide film having a film speed of at least 700 and comprising a support that has first and second major surfaces and that is capable of transmitting X-radiation,
said radiographic silver halide film having disposed on said first major support surface, two or more hydrophilic colloid layers including first and second silver halide emulsion layers, and having on said second major support surface, two or more hydrophilic colloid layers including third and fourth silver halide emulsion layers, said first and third silver halide emulsion layers being the outermost emulsion layers on their respective sides of said support,
each of said first, second, third, and fourth silver halide emulsion layers comprising tabular silver halide grains that have the same or different composition and independently an aspect ratio of at least 35 and an average grain diameter of at least 3.0 μm and comprise at least 90 mol % bromide and up to 3 mol % iodide, both based on total silver in said grains,
said second and fourth silver halide emulsion layers comprising a crossover control agent sufficient to reduce crossover to less than 10%, and
B) a fluorescent intensifying screen arranged on each side of said radiographic silver halide film, said screen having a screen speed of at least 150 and a screen sharpness measurement (SSM) value greater than reference Curve A of FIG. 4, and comprising an inorganic phosphor capable of absorbing X-rays and emitting electromagnetic radiation having a wavelength greater than 300 nm, said inorganic phosphor being coated in admixture with a polymeric binder in a phosphor layer onto a flexible support and having a protective overcoat disposed over said phosphor layer.

2. The radiographic imaging assembly of claim 1 wherein said tabular silver halide grains in said first, second, third, and fourth silver halide emulsion layers are composed of at least 95 mol % bromide and up to 0.5 mol % iodide, both based on total silver in the emulsion layer.

3. The radiographic imaging assembly of claim 1 wherein said tabular silver halide grains in said first, second, third, and fourth silver halide emulsion layers independently have an aspect ratio of from about 40 to about 50, an average grain diameter of at least 4.0 μm, and independently an average thickness of from about 0.08 to about 0.12 μm.

4. The radiographic imaging assembly of claim 1 wherein said tabular silver halide grains in said first, second, third, and fourth silver halide emulsion layers have essentially the same aspect ratio of from about 40 to about 50, an average grain diameter of at least 4.0 μm, and essentially the same average thickness of from about 0.09 to about 0.11 μm.

5. The radiographic imaging assembly of claim 1 wherein said tabular silver halide grains in said first, second, third, and fourth silver halide emulsion layers are dispersed in a hydrophilic polymeric vehicle mixture comprising at least 0.25% of oxidized gelatin, based on the total dry weight of said polymeric vehicle mixture.

6. The radiographic imaging assembly of claim 1 wherein said tabular AgX grains in said first, second, third, and fourth silver halide emulsion layers are dispersed in up to 1.5% deionized oxidized gelatin.

7. The radiographic imaging assembly of claim 6 wherein said tabular AgX grains in said first, second, third, and fourth silver halide emulsion layers are dispersed in from about 0.4 to about 0.6% deionized oxidized gelatin.

8. The radiographic imaging assembly of claim 1 wherein the dry, unprocessed thickness ratio of said first silver halide emulsion layer to that of said second silver halide emulsion layer is greater than 1:1, and the dry, unprocessed thickness ratio of said third silver halide emulsion layer to that of said fourth silver halide emulsion layer is independently greater than 1:1.

9. The radiographic imaging assembly of claim 1 wherein the molar ratio of silver in said first silver halide emulsion layer to that of said second silver halide emulsion layer is greater than 1:1, and the molar ratio of silver in said third silver halide emulsion layer to that of said fourth silver halide emulsion layer is independently greater than 1:1, the amount polymer vehicle on each side of said support is from about 30 to about 40 mg/dm², and the level of silver on each side of said support is from about 18 to about 24 mg/dm².

10. The radiographic imaging assembly of claim 1 wherein said crossover control agent in said radiographic silver halide film is present in an amount sufficient to reduce crossover to less than 8%.

11. The radiographic imaging assembly of claim 1 wherein said crossover control agent is a particulate merocyanine or oxonol dye that is present in each of said second and fourth silver halide emulsion layers in an amount of from about 0.75 to about 1.5 mg/m².

12. The radiographic imaging assembly of claim 1 wherein said inorganic phosphor is calcium tungstate, activated or unactivated lithium stannates, niobium and/or rare earth activated or unactivated yttrium, lutetium, or gadolinium tantalates, rare earth-activated or unactivated middle chalcogen phosphors such as rare earth oxychalcogenides and oxyhalides, or terbium-activated or unactivated lanthanum or lutetium middle chalcogen phosphor, or said inorganic phosphor contains hafnium.

13. The radiographic imaging assembly of claim 1 wherein said inorganic phosphor is a rare earth oxychalcogenide and oxyhalide phosphor that is represented by the following formula (1):
M′_{(w-n)}M″ₙO_{w}X′ (1)
wherein M′ is at least one of the metals yttrium (Y), lanthanum (La), gadolinium (Gd), or lutetium (Lu), M″ is at least one of the rare earth metals, preferably dysprosium (Dy), erbium (Er), europium (Eu), holmium (Ho), neodymium (Nd), praseodymium (Pr), samarium (Sm), tantalum (Ta), terbium (Th), thulium (Tm), or ytterbium (Yb), X′ is a middle chalcogen (S, Se, or Te) or halogen, n is 0.002 to 0.2, and w is 1 when X′ is halogen or 2 when X′ is a middle chalcogen.

14. The radiographic imaging assembly of claim 13 wherein said inorganic phosphor is a lanthanum oxybromides, or terbium-activated or thulium-activated gadolinium oxides.

15. The radiographic imaging assembly of claim 1 wherein said inorganic phosphor is an alkaline earth metal phosphor that is the product of firing starting materials comprising optional oxide and a combination of species characterized by the following formula (2):
MFX_{1-z}I_{z}uM^{a}X^{a}:yA:eQ:tD (2)
wherein “M” is magnesium (Mg), calcium (Ca), strontium (Sr), or barium (Ba), “F” is fluoride, “X” is chloride (Cl) or bromide (Br), “I” is iodide, M^{a} is sodium (Na), potassium (K), rubidium (Rb), or cesium (Cs), X^{a} is fluoride (F), chloride (Cl), bromide (Br), or iodide (I), “A” is europium (Eu), cerium (Ce), samarium (Sm), or terbium (Th), “Q” is BeO, MgO, CaO, SrO, BaO, ZnO, Al₂O₃, La₂O₃, In₂O₃, SiO₂, TiO₂, ZrO₂, GeO₂, SnO₂, Nb₂O₅, Ta₂O₅, or ThO₂, “D” is vanadium (V), chromium (Cr), manganese (Mn), iron (Fe), cobalt (Co), or nickel (Ni), “z” is 0 to 1, “u” is from 0 to 1, “y” is from 1×10⁻⁴ to 0.1, “e” is form 0 to 1, and “t” is from 0 to 0.01.

16. A radiographic imaging assembly having a system speed of at least 400 and comprising:
A) a symmetric radiographic silver halide film having a film speed of at least 800 and comprising a support that has first and second major surfaces and that is capable of transmitting X-radiation,
said radiographic silver halide film having disposed on said first major support surface, two or more hydrophilic colloid layers including first and second silver halide emulsion layers, and having on said second major support surface, two or more hydrophilic colloid layers including third and fourth silver halide emulsion layers, said first and third silver halide emulsion layers being the outermost emulsion layers on their respective sides of said support,
each of said first, second, third, and fourth silver halide emulsion layers comprising tabular silver halide grains that have the same composition, independently an aspect ratio of from about 40 to about 50, an average grain diameter of at least 4.0 μm, and an average thickness of from about 0.09 to about 0.11 μm, and comprise at least 98 mol % bromide and up to 0.5 mol % iodide, both based on total silver in said grains,
each of said second and fourth silver halide emulsion layers comprising a particulate oxonol dye as a crossover control agent present in an amount of from about 1 to about 1.3 mg/m² that is sufficient to reduce crossover to less than 8% and that is decolorized during development within 45 seconds,
said film further comprising a protective overcoat on both sides of said support disposed over all of said silver halide emulsion layers,
wherein said tabular silver halide grains in said first, second, third, and fourth silver halide emulsion layers are dispersed in a hydrophilic polymeric vehicle mixture comprising from about 0.25 to about 1.5% of deionized oxidized gelatin, based on the total dry weight of said polymeric vehicle mixture,
wherein the dry, unprocessed thickness ratio of said first silver halide emulsion layer to that of said second silver halide emulsion layer is from about 3:1 to about 1:1, and the dry, unprocessed thickness ratio of said third silver halide emulsion layer to that of said fourth silver halide emulsion layer is independently from about 3:1 to about 1:1, and
wherein the molar ratio of silver in said first silver halide emulsion layer to that of said second silver halide emulsion layer is from about 1.5:1 to about 3:1, and the molar ratio of silver in said third silver halide emulsion layer to that of said fourth silver halide emulsion layer is independently from about 1.5:1 to about 3:1, and
B) a fluorescent intensifying screen having a screen speed of at least 150 and a screen sharpness measurement (SSM) value that is at least 1.1 times that of reference Curve A of FIG. 4 at a given spatial frequency, and that comprises a terbium activated gadolinium oxysulfide phosphor capable of absorbing X-rays and emitting electromagnetic radiation having a wavelength greater than 300 nm, said phosphor being coated in admixture with a polymeric binder in a phosphor layer onto a flexible polymeric support and having a protective overcoat disposed over said phosphor layer.

17. The radiographic imaging assembly of claim 16 wherein two fluorescent intensifying screens are arranged in association with said radiographic silver halide film, one of either side thereof.

18. A method of providing a black-and-white image comprising exposing the radiographic silver halide film in the radiographic imaging assembly of claim 1 and processing said film, sequentially, with a black-and-white developing composition and a fixing composition, the processing being carried out within 90 seconds, dry-to-dry.

19. The method of claim 18 wherein the black-and-white image so provided is used for a medical diagnosis.
